(19) United States
(12) Patent Application Publication
(10) Pub. No.: US 2002/0149184 A1
(43) Pub. Date: Oct. 17, 2002

(54) Method and device for controlling the operation of a vehicle-occupant protection device assigned to a seat, in particular in a motor vehicle

(76) Inventors: Ludwig Ertl, Regensburg (DE); Thorsten Kohler, Deuerling (DE); Dirk Zittlau, Stockelsberg (DE)

Correspondence Address: LERNER AND GREENBERG, P.A., PAYENT ATTORNEYS AND ATTORNEYS AT LAW, Post Office Box 2480, Hollywood, FL, 33022-2480, US

(21) Appl. No.: 10/095,314

(22) Filed: Mar. 11, 2002

Related U.S. Application Data
(63) Continuation of application No. PCT/DE00/03083, filed on Sep. 6, 2000.

(30) Foreign Application Priority Data
Sep. 10, 1999 (DE) 199 43 384.4

(51) Int. Cl. B60K 28/10; B60R 21/18

(52) U.S. Cl. 280/733; 180/274

(57) ABSTRACT

A three-dimensional image-forming method is utilized to generate three-dimensional position surface image data of an unoccupied seat and of a seat which is occupied with an object. By subtracting one of the image data items from the other one, the volume of a person located on the seat is determined. As a result, a vehicle-occupant protection device which is assigned to the seat can be controlled as a function of the position and the volume or weight of the person.

### CROSS-REFERENCE TO RELATED APPLICATION

This application is a continuation of copending International Application No. PCT/DE00/03083, filed Sep. 6, 2000, which designated the United States.

### BACKGROUND OF THE INVENTION

### Field of the Invention

The invention relates to a method and a device for controlling the operation of a vehicle-occupant protection device assigned to a seat, in particular in a motor vehicle.

In the last few years, vehicle-occupant protection systems such as airbags and/or seatbelt pre-tensioning devices, and the like have become standard safety equipment in motor vehicles. As these systems become more widespread, cases have also occurred wherein in particular the inflation of an airbag has led to injuries because there was an absence of information on the type of seat occupation and the position of a person located on the seat and the person's characteristic features, for example their weight. The inflation procedure of the airbag is therefore configured in such a way that in the event of an accident an adult person who is wearing a seatbelt is not thrown against a hard object, for example the dashboard or the steering wheel. If the head of the person is too close to the steering wheel or the dashboard (out off position) at the time of the triggering of the airbag this configuration can lead to injuries.

In order to remedy this problem, systems are in development which use a wide variety of methods to measure average distances in a certain volume under examination and to determine the distance between the steering wheel or the dashboard and a person so that the airbag can be triggered and fired in accordance with the requirements. In addition, there are systems which use weight sensors of a wide variety of designs, such as seat mats, strain gauges etc., to sense the type of seat occupation, in particular the weight of a person sitting on the seat, as a triggering parameter. The measurement of the weight is problematic because the sensors used are in part very costly and difficult to attach to the seat. Furthermore, the measured values acquired can be interpreted only with difficulty.

German published patent application DE 196 25 890 A1 discloses a control method for a safety device of a vehicle wherein a person located on a seat is imaged using an optical or infrared camera in order to register their posture and dimensions. A table that assigns the weight of the respective person to the body dimensions is stored in an electronic control device. The assignment is comparatively imprecise because the weight of persons of equal size can differ considerably.

### SUMMARY OF THE INVENTION

It is accordingly an object of the invention to provide a method and a device for controlling the operation of a vehicle-occupant protection device assigned to a seat, in particular in a motor vehicle, which overcome the above-mentioned disadvantages of the heretofore-known devices and methods of this general type such that the operation of the vehicle-occupant protection device can be adapted to the respective requirements in an improved way.

With the foregoing and other objects in view there is provided, in accordance with the invention, a method of controlling an operation of a protection device, in particular a vehicle-occupant protection device in a motor vehicle. The method comprises:

acquiring a position and geometric dimensions of an object, such as a person, located on a seat;

determining a volume of the object located on the seat; and

controlling an operation of a protection device assigned to the seat in dependence on the volume of the object on the seat.

In other words, the volume of the object disposed on the seat, in particular of a person, is determined. From the volume it is possible to infer the weight of the person in a relatively precise way so that the operation of the vehicle-occupant protection device can be adapted to this weight.

In accordance with an added feature of the invention, the operation of the protection device is incrementally changed, and the increments of change are adjusted in dependence of the volume.

In accordance with an additional feature of the invention, a shape of the volume of the object located on the seat is determined, and the protection device is controlled in dependence on the shape of the volume.

In accordance with another feature of the invention:

the acquiring step comprises generating a three-dimensional position surface image of a seat surface and a backrest surface of seat in an unoccupied state, and generating a three-dimensional position surface image of the object located on the seat; and

the determining step comprises comparing the position surface images with one another to determine the volume.

In accordance with a further feature of the invention, the three-dimensional position surface image of the unoccupied seat is generated by an image-forming method.

In accordance with again an additional feature of the invention, a position surface image of the seating surface of the unoccupied seat is generated from a three-dimensional surface image of the seat and a signal supplied by at least one sensor sensing a relative position of the seat.

In accordance with again an added feature of the invention, a seat-occupation sensor is used to determine whether or not the seat is occupied.

With the above and other objects in view there is also provided, in accordance with the invention, a device for controlling an operation of a protection device assigned to a seat, such as an occupant protection device in a motor vehicle, comprising:

an image data generation device for generating electronic, three-dimensional position surface image data of the seat in an unoccupied state and of the seat in an occupied state in which an object is located on the seat;

a comparison device connected to said image data generation device for comparing the three-dimensional position surface image data of the occupied state and of the unoccupied state of the seat, for determining therefrom image data of a surface image of the object located on the seat, and for determining therefrom a volume of the object; and

an actuation device connected to said comparison device for actuating the protection device in dependence on the volume of the object located on the seat.

In accordance with a concomitant feature of the invention, there is provided a device for sensing a shape of the object located on the seat by reference to the three-dimensional surface image data for categorizing a sensed shape in accordance with predetermined categories, and for generating and feeding a category signal to said actuation device for actuating the protection device.

The invention is suitable for any types of vehicle-occupant protection devices which are assigned to a seat, for example seats in aircraft, in boats, in all types of land vehicles, etc. The vehicle-occupant protection device can be a seatbelt pre-tensioning device, an airbag device or some other device which, in the event of an accident, is intended to protect a person located on the seat against injuries.

Other features which are considered as characteristic for the invention are set forth in the appended claims.

Although the invention is illustrated and described herein as embodied in a method and device for controlling the operation of a vehicle-occupant protection device assigned to a seat, in particular in a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic view of the device according to the invention with a block circuit diagram; and

FIG. 2 are three related perspective sketches explaining the invention.

### DESCRIPTION OF THE PREFERRED EMBODIMENTS

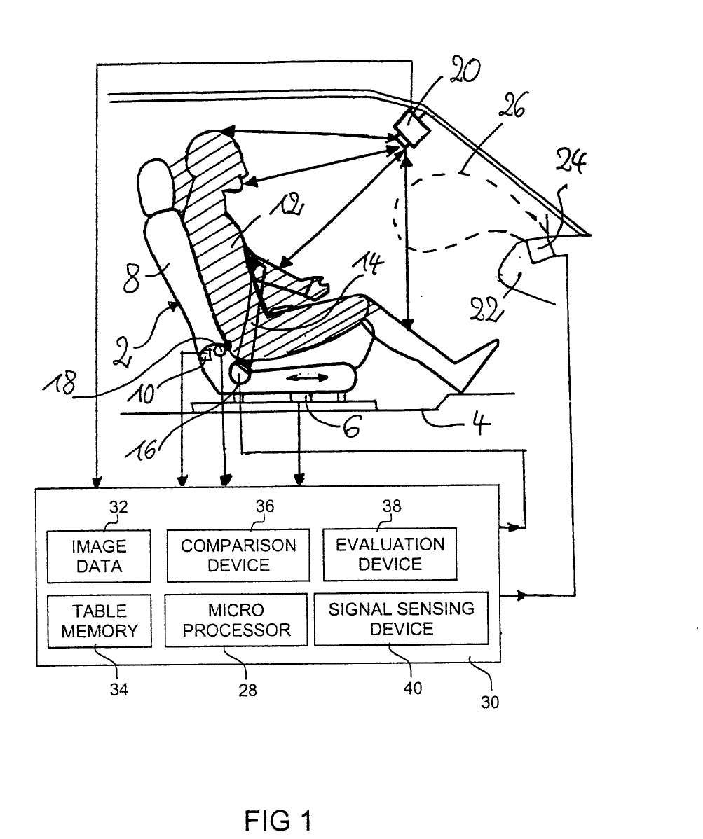

Referring now to the figures of the drawing in detail and first, particularly, to FIG. 1 thereof, there is shown a seat 2, which, in the illustrated example, is a front seat passenger's seat. The seat 2 is longitudinally displaceably attached to a base 4 of the vehicle. The position of the seat frame can be sensed by a sensor 6, for example a potentiometer which is coupled to an electric motor in order to displace the seat.

The inclination of a backrest 8 can be sensed by an inclination sensor 10.

A person 12, who is wearing a seatbelt 14, is seated on the seat 2. A seatbelt pre-tensioning device 16, which operates, for example, electrically or pyro-electrically is provided in order to tense the seatbelt 14. The fact whether the seat is occupied can be sensed by an occupant sensor 18 which can be embodied as a sensor mat, individual sensor or in some other way.

A 3-D camera device 20 (illustrated in enlarged form in FIG. 1) for generating three-dimensional position surface image data is attached to the headliner or the roof lining of the vehicle above the windshield in front of the person 12. In order to generate the three-dimensional position surface image data, a wide variety of distance measuring methods can be applied. For example, it is possible to triangulate with light sections, where the scene to be imaged is illuminated with a suitable pattern (for example lines) and a triangulation is carried out using a camera that views the scene at an angle. Depending on the number of lines, a quantity of points with distance values is obtained. Other suitable methods are stereoscopic imaging methods, laser light delay time measuring devices, and the like. In laser light delay time measuring methods, the scene can be illuminated, for example, from a central light source and the light which is incident on a photodiode array and which is reflected by the scene is evaluated in a direction-selected fashion resulting in the generation of a three-dimensional surface image which gives the distance of the image points from the photodiode array as a function of the distance. Under position surface image data, data are collected which give or contain the absolute position of an image surface point relative to a reference point, i.e. direction and distance.

In front of the front seat passenger's seat there is provided an airbag device 24 in a dashboard 22. An inflated airbag 26 of the airbag device 24 is indicated by dashed lines. The airbag device 24 contains, for example, a plurality of firing caps and gas generators which can be fired selectively so that the inflation speed and/or the pressure up to which the airbag 26 is inflated can be controlled.

Inputs of an electronic control device 30, which contains a microprocessor 28 with associated memory devices and whose construction and basic functions are known to those of skill in the art and will therefore not described in detail here, are connected to the 3-D camera device 20, the inclination sensor 10, the seat occupation sensor 18, the sensor 6 and, if appropriate, further sensors such as acceleration sensors etc. The control device 30 has outputs connected to the airbag device 24 and to the seatbelt pre-tensioning device 16.

The control device 30 contains a device 32 for storing electronic position surface image data which are recorded by the 3-D camera device 20, a memory 34 for storing tables which can be programmed into it, a comparator device 36, and an evaluation device 38 for generating output signals and a sensor-signal-sensing device 40.

The devices which are illustrated as function blocks within the control device 30 can be divided up in different ways in terms of hardware and software.

The function of the system described is as follows:

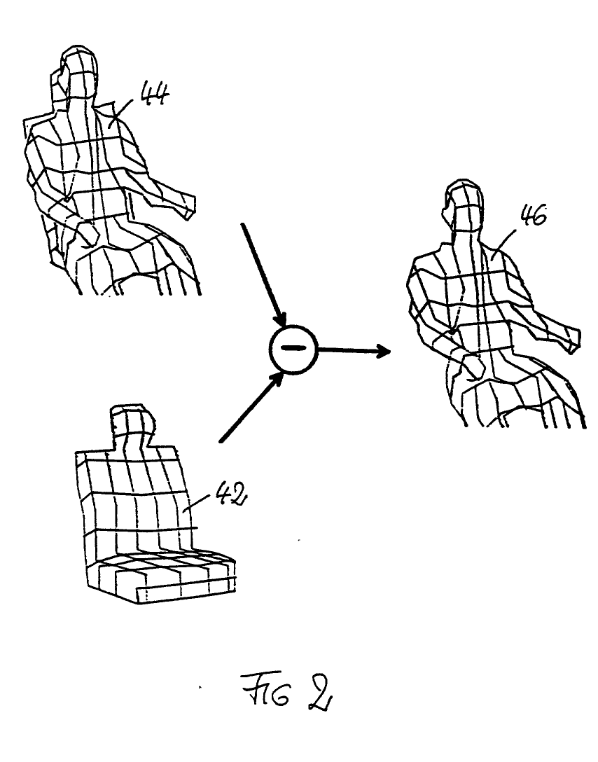

A three-dimensional position surface image of the unoccupied seat 2 can be generated, for example, by virtue of the fact that an image of the non-occupied seat surface is taken by the 3-D camera device 20. Depending on the structure of the camera device, the three-dimensional position surface image is a raster image 42 (screen-dot image) according to FIG. 2 whose points are known, in a coordinate system referred for example to a point of the camera device 20, in terms of their direction and their distance. By means of the individual image points, the unoccupied vehicle seat is covered with grating lines which intersect at the image points and which permit approximate sensing of the entire surface of the seat by means of interpolation. This ensures that the seat is not occupied at the time when the image is taken, an image is taken only if the occupation sensor 18 generates a signal which indicates the non-occupation of the seat. In addition, the position of the seat during the generation of the position surface image 42 is recorded by means of the output signals of sensors 6 and 18 which are read out by the sensor-sensing device 40. A three-dimensional position surface image which gives the position of each surface point of the non-occupied seat with respect to a coordinate system which is fixed to the vehicle is thus made available in the image data memory 32.

The three-dimensional position surface image 42 can also be generated by data of a surface image of the seat backrest and of the seat cushion being stored in the data memory 34 which contain relative positions of the surface points in relation to one another and are referred to reference points of the output signal of the inclination sensor 10 and of the displacement sensor 6. For respective values of the output signals of the displacement sensor 6 and of the inclination sensor 10 it is possible to generate data which correspond to a three-dimensional position surface image 42 of the seat 2, which data are then calculated from the pre-stored surface image data and the output signals of the sensors 6 and 10 and stored in the memory 32.

The 3-D camera device 20 is used to take a three-dimensional position surface image of the seat which is occupied by the person 12 and is designated in FIG. 2 by 44. This image is advantageously taken at short time intervals so that it is continuously available. In the case of an imminent accident, for example when the vehicle decelerates above a predetermined value, the position surface image can be generated with an evaluation algorithm that is, if appropriate, modified and which operates more quickly or more precisely.

By subtracting the three-dimensional position surface image data of the image 42 from the data of the image 44 in the comparison device 36, it is possible to generate the three-dimensional surface image 46 from which the volume of the person seated on the seat can be calculated (dashed in FIG. 1).

Of course, when the image 42 is subtracted from the image 44 it is checked that the seat is in the same position when the image 44 and the image 42 are taken. If this is not the case, the position surface image of the unoccupied seat is converted, by means of the output signals of the sensors 6 and 10, into the position surface image that corresponds to the seat in the occupied position wherein the image 44 is taken.

In order to take into account surface changes of the unoccupied seat such as occur when the seat is occupied by the person 12, corresponding correction algorithms may be stored in the comparison device 36.

The volume and the weight of the person, determined therefrom by means of predetermined tables, can be calculated from the surface image data 46 so that signals which trigger and control the airbag device 24 and/or the seatbelt pre-tensioning device 16 in accordance with the position and/or the weight of the person 12 can be calculated in the evaluation device 38.

Furthermore, image patterns which correspond, for example, to a child's carrying basket, a child's seat, a child, a person of average size, a fat person, a thin person, etc. and by reference to which it is possible to categorize the surface image 46 can be stored in the data memory 34, so that the safety devices is triggered, or if required not triggered, in accordance with the category determined. It goes without saying that when persons are detected the volumes can be divided into different classes so that the safety devices can be correspondingly placed in the respective volume and weight classes. Fine categorization, for example small persons with a large volume or a large person with a small volume, makes possible assignments between volume and weight so that triggering can be matched relatively precisely to the respective person.

The assignment can be changed in a wide variety of ways. For example, in the region of the vehicle roof lining it is possible to arrange a plurality of 3-D camera devices with which the position surface images can be taken from different perspectives so that a more precise determination of the volume is possible.

The invention makes it possible to determine precisely both the distance of parts which are at risk of collision, for example the head, from hard objects, and the volumes, and thus the weights, of the persons to be protected, so that vehicle occupants can be effectively protected.

We claim:

1. A method of controlling an operation of a protection device, which comprises:
acquiring a position and geometric dimensions of an object located on a seat;
determining a volume of the object located on the seat; and
controlling an operation of a protection device assigned to the seat in dependence on the volume of the object on the seat.

2. The method according to claim 1, wherein the object is a person and the protection device is a vehicle-occupant protection system in a motor vehicle.

3. The method according to claim 1, which comprises incrementally changing the operation of the protection device, and adjusting increments of a change in dependence of the volume.

4. The method according to claim 1, which comprises determining a shape of the volume of the object located on the seat, and controlling the protection device in dependence on the shape of the volume.

5. The method according to claim 1, wherein:
the acquiring step comprises generating a three-dimensional position surface image of a seat surface and a backrest surface of seat in an unoccupied state, and generating a three-dimensional position surface image of the object located on the seat; and
the determining step comprises comparing the position surface images with one another to determine the volume.

6. The method according to claim 5, the step of generating the three-dimensional position surface image of the unoccupied seat by an image-forming method.

7. The method according to claim 5, which comprises sensing with a seat-occupation sensor whether or not the seat is occupied.

8. The method according to claim 1, wherein a position surface image of the seating surface of the unoccupied seat is generated from a three-dimensional surface image of the seat and a signal supplied by at least one sensor sensing a relative position of the seat.

9. The method according to claim 8, which comprises sensing with a seat-occupation sensor whether or not the seat is occupied.

10. A device for controlling an operation of a protection device assigned to a seat, comprising:
an image data generation device for generating electronic, three-dimensional position surface image data of the seat in an unoccupied state and of the seat in an occupied state in which an object is located on the seat;
a comparison device connected to said image data generation device for comparing the three-dimensional position surface image data of the occupied state and of the unoccupied state of the seat, for determining therefrom image data of a surface image of the object located on the seat, and for determining therefrom a volume of the object; and
an actuation device connected to said comparison device for actuating the protection device in dependence on the volume of the object located on the seat.

11. The device according to claim 10, wherein the seat is a seat in a motor-vehicle and the protection device is a motor vehicle occupant protection device.

12. The device according to claim 9, which comprises a device for sensing a shape of the object located on the seat by reference to the three-dimensional surface image data for categorizing a sensed shape in accordance with predetermined categories, and for generating and feeding a category signal to said actuation device for actuating the protection device.
